(19) United States
(12) Patent Application Publication
(10) Pub. No.: US 2007/0187258 A1
(43) Pub. Date: Aug. 16, 2007

(54) Method for electrochemically polishing a conductive material on a substrate

(76) Inventors: Tianbao Du, Santa Clara, CA (US); Feng Q. Liu, San Jose, CA (US); Alain Duboust, Sunnyvale, CA (US); Wei-Yung Hsu, Santa Clara, CA (US); Liang-Yuh Chen, Foster City, CA (US)

Correspondence Address: PATTERSON & SHERIDAN, LLP, 3040 POST OAK BOULEVARD, SUITE 1500, HOUSTON, TX, 77056, US

(21) Appl. No.: 11/355,769

(22) Filed: Feb. 15, 2006

(51) Int. Cl. B23H 5/00

(52) U.S. Cl. 205/646

(57) ABSTRACT

Methods are provided for removing conductive materials from a substrate surface. In one aspect, a method includes providing a substrate comprising dielectric feature definitions formed between substrate field regions, a barrier material disposed in the feature definitions and on the substrate field regions, and a conductive material disposed on the barrier material, polishing the substrate to substantially remove a bulk portion of the conductive material with a direct current bias, and polishing the substrate to remove a residual portion of the conductive material with a pulse bias.

### BACKGROUND OF THE INVENTION

1. Field of the Invention

Embodiments of the present invention relate to methods for removing a conductive material from a substrate.

2. Background of the Related Art

Reliably producing sub-half micron and smaller features is one of the key technologies for the next generation of very large scale integration (VLSI) and ultra large-scale integration (ULSI) of semiconductor devices. However, as the limits of circuit technology are pushed, the shrinking dimensions of interconnects in VLSI and ULSI technology have placed additional demands on processing capabilities. Reliable formation of interconnects is important to VLSI and ULSI success and to the continued effort to increase circuit density and quality of individual substrates and die.

Multilevel interconnects are formed using sequential material deposition and material removal techniques on a substrate surface to form features therein. As layers of materials are sequentially deposited and removed, the uppermost surface of the substrate may become non-planar across its surface and require planarization prior to further processing. Planarization or “polishing” is a process where material is removed from the surface of the substrate to form a generally even, planar surface. Planarization is useful in removing excess deposited material, removing undesired surface topography, and surface defects, such as surface roughness, agglomerated materials, crystal lattice damage, scratches and contaminated layers or materials to provide an even surface for subsequent photolithography and other semiconductor processes.

Chemical mechanical planarization or chemical mechanical polishing (CMP) is a common technique used to planarize substrates. In conventional CMP techniques, a substrate carrier or polishing head is mounted on a carrier assembly and positioned in contact with a polishing article in a CMP apparatus. The carrier assembly provides a controllable pressure to the substrate urging the substrate against the polishing pad. The pad is moved relative to the substrate by an external driving force. Thus, the CMP apparatus effects polishing or rubbing movement between the surface of the substrate and the polishing article while dispersing a polishing composition to effect both chemical activity and mechanical activity.

However, materials deposited on the surface of a substrate to fill feature definitions formed therein often result in unevenly formed surfaces over feature definitions of variable density. Referring to FIG. 1A, a metal layer 20 is deposited on a substrate 10 to fill wide feature definitions 30, also known as low density feature definitions, or narrow feature definitions 40, also known as and high density feature definitions. Excess material, called overburden, may be formed with a greater thickness 45 over the narrow feature definitions 40 and may have minimal deposition 35 over wide feature definitions 30. Polishing of surfaces with overburden may result in the retention of residues 50 from inadequate metal removal over narrow features. Overpolishing processes to remove such residues 50 may result in excess metal removal over wide feature definitions 30. Excess metal removal can form topographical defects, such as concavities or depressions known as dishing 55, over wide features, as shown in FIG. 1B.

Dishing of features and retention of residues on the substrate surface are undesirable since dishing and residues may detrimentally affect subsequent processing of the substrate. For example, dishing results in a non-planar surface that impairs the ability to print high-resolution lines during subsequent photolithographic steps and detrimentally affects subsequent surface topography of the substrate, which affects device formation and yields. Dishing also detrimentally affects the performance of devices by lowering the conductance and increasing the resistance of the devices, causing device variability and device yield loss. Residues may lead to uneven polishing of subsequent materials, such as barrier layer materials (not shown) disposed between the conductive material and the substrate surface. Post CMP profiles generally show higher dishing on wide trenches than on narrow trenches or dense areas. Uneven polishing will also increase defect formation in devices and reduce substrate yields.

Also, substrate polishing processes must be very efficient to increase the throughput production. Often, defects are formed on substrates that are over polished due to an increase in process variables, such as chemical concentrations, electrical potentials and/or pressure of polishing articles. Some of these defects may be minimized by decreasing these variables, but with an increase of time and loss of throughput production.

Therefore, there is a need for methods for removing conductive material from a substrate that minimizes the formation of topographical defects to the substrate during planarization.

### SUMMARY OF THE INVENTION

Aspects of the invention provide compositions and methods for removing conductive materials by an electrochemical polishing technique. In one aspect, a method is provided for processing a substrate including providing the substrate comprising dielectric feature definitions formed between substrate field regions, a barrier material disposed in the feature definitions and on the substrate field regions, and a conductive material disposed on the barrier material, polishing the substrate to substantially remove first portion of the conductive material with a direct current bias, and polishing the substrate to remove a second portion of the conductive material with a pulse bias.

In another aspect, a method is provided for processing a substrate including providing the substrate comprising dielectric feature definitions formed between substrate field regions, a barrier material disposed in the feature definitions and on the substrate field regions, and a conductive material disposed on the barrier material, polishing the substrate to substantially remove a first portion of the conductive material, polishing the substrate to remove a second portion of the conductive material, including applying a first direct current bias to the substrate, applying a pulse bias to the substrate, and then applying a second direct current bias to the substrate.

### BRIEF DESCRIPTION OF THE DRAWINGS

So that the manner in which the above recited aspects of the present invention are attained and can be understood in detail, a more particular description of embodiments of the invention, briefly summarized above, may be had by reference to the embodiments thereof which are illustrated in the appended drawings.

It is to be noted, however, that the appended drawings illustrate only typical embodiments of this invention and are therefore not to be considered limiting of its scope, for the invention may admit to other equally effective embodiments.

FIGS. 1A and 1B schematically illustrate the phenomenon of dishing and erosion respectively;

FIG. 2 is a plan view of an electrochemical mechanical planarizing system;

FIGS. 3A-3E are schematic cross-sectional views illustrating a polishing process performed on a substrate according to one embodiment.

FIG. 4 illustrates voltage application verse time for one embodiment of a polishing process;

FIGS. 5A-5C illustrate some embodiments of bias application for one step of an electrochemical polishing process;

FIGS. 6A-6F illustrate some embodiments of bias application for another step of an electrochemical polishing process;

FIG. 7A-7C are schematic cross-sectional views illustrating a polishing process performed on a substrate according to another embodiment.

### DETAILED DESCRIPTION OF THE PREFERRED EMBODIMENT

In general, aspects of the invention provide methods and compositions for removing conductive materials from a substrate surface by an electrochemical mechanical polishing (Ecmp) technique. The invention is described below in reference to a planarizing process for the removal of conductive material from a substrate surface by application of biasing techniques.

The words and phrases used herein should be given their ordinary and customary meaning in the art by one skilled in the art unless otherwise further defined. Chemical polishing should be broadly construed and includes, but is not limited to, planarizing a substrate surface using chemical activity. Electropolishing should be broadly construed and includes, but is not limited to, planarizing a substrate by the application of electrochemical activity. Electrochemical mechanical polishing (Ecmp) should be broadly construed and includes planarizing a substrate by the application of electrochemical activity, mechanical activity, and chemical activity to remove material from a substrate surface.

Anodic dissolution should be broadly construed and includes, but is not limited to, the application of an anodic bias to a substrate directly or indirectly which results in the removal of conductive material from a substrate surface and into a surrounding polishing composition. Polishing composition should be broadly construed and includes, but is not limited to, a composition that provides ionic conductivity, and thus, electrical conductivity, in a liquid medium, which generally comprises materials known as electrolyte components. The amount of each electrolyte component in polishing compositions can be measured in volume percent or weight percent. Volume percent refers to a percentage based on volume of a desired liquid component divided by the total volume of all of the liquid in the complete composition. A percentage based on weight percent is the weight of the desired component divided by the total weight of all of the liquid components in the complete composition.

The electrochemical mechanical polishing process may be performed in a process apparatus, such as a platform having one or more polishing stations adapted for electrochemical mechanical polishing processes. The one or more polishing stations may be adapted to perform conventional chemical mechanical polishing. A platen for performing an electrochemical mechanical polishing process may include a polishing article, a first electrode, and a second electrode, wherein the substrate is in electrical contact with the second electrode. An example of a suitable system is the Reflexion Lk Ecmp™ processing system, commercially available from Applied Materials, Inc., of Santa Clara, Calif. The following apparatus description is illustrative and should not be construed or interpreted as limiting the scope of the invention.

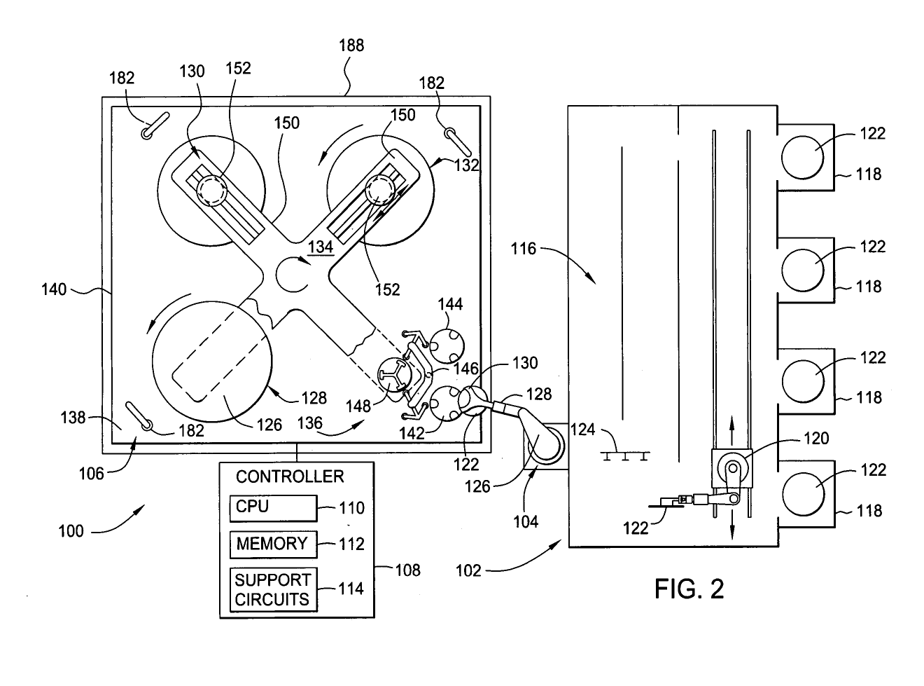

FIG. 2 is a plan view of one embodiment of an exemplary planarization system 100 having an apparatus for electrochemically processing a substrate. The planarization system 100 generally comprises a factory interface 102, a loading robot 104, and a planarizing module 106. The loading robot 104 is disposed proximate the factory interface 102 and the planarizing module 106 to facilitate the transfer of substrates 122 therebetween.

A controller 108 is provided to facilitate control and integration of the modules of the planarization system 100. The controller 108 comprises a central processing unit (CPU) 110, a memory 112, and support circuits 114. The controller 108 is coupled to the various components of the planarization system 100 to facilitate control of, for example, the planarizing, cleaning, and transfer processes.

The factory interface 102 generally includes a cleaning module 116 and one or more wafer cassettes 118. An interface robot 120 is employed to transfer substrates 122 between the wafer cassettes 118, the cleaning module 116 and an input module 124. The input module 124 is positioned to facilitate transfer of substrates 122 between the planarizing module 106 and the factory interface 102 by grippers, for example vacuum grippers or mechanical clamps (not shown).

The planarizing module 106 includes at least a first electrochemical mechanical planarizing (Ecmp) station 128, disposed in an environmentally controlled enclosure 188. Examples of planarizing modules 106 that can be adapted to benefit from the invention include MIRRA® Chemical Mechanical Planarizing Systems, MIRRA MESA™ Chemical Mechanical Planarizing Systems, REFLEXION® Chemical Mechanical Planarizing Systems, REFLEXION® LK Chemical Mechanical Planarizing Systems, and REFLEXION LK Ecmp™ Chemical Mechanical Planarizing Systems, all available from Applied Materials, Inc. of Santa Clara, Calif. Other planarizing modules, including those that use processing pads, planarizing webs, or a combination thereof, and those that move a substrate relative to a planarizing surface in a rotational, linear or other planar motion may also be adapted to benefit from the invention.

In the embodiment depicted in FIG. 2, the planarizing module 106 includes a Ecmp station 128, a second Ecmp station 130 and third polishing station 132. The third polishing station may be an Ecmp station as described for Ecmp stations 128 or 130 as shown in FIG. 2, and may alternatively, be a chemical mechanical polishing (CMP) station. As CMP stations are conventional in nature, further description thereof has been omitted for the sake of brevity. However, an example of a suitable CMP polishing station is more fully described in U.S. Pat. No. 5,738,574, issued on Apr. 14, 1998, entitled, “Continuous Processing System for Chemical Mechanical Polishing,” the entirety of which is incorporated herein by reference to the extent not inconsistent with the invention

Initial removal of a first portion of the conductive material, bulk material removal, from the substrate is performed through an electrochemical dissolution process at the Ecmp station 128. After the bulk material removal at the Ecmp station 128, removal of a second portion of the conductive material, residual conductive material removal, is performed at the Ecmp station 130 through a second electrochemical mechanical process. It is contemplated that more than one residual Ecmp stations 130 may be utilized in the planarizing module 106. Barrier layer material may be removed at polishing station 132 after processing at the residual Ecmp station 130 by the barrier removal processes described herein. Alternatively, each of the first and second Ecmp stations 128, 130 may be utilized to perform both the two-step conductive material removal as described herein on a single station.

The exemplary planarizing module 106 also includes a transfer station 136 and a carousel 134 that are disposed on an upper or first side 138 of a machine base 140. In one embodiment, the transfer station 136 includes an input buffer station 142, an output buffer station 144, a transfer robot 146, and a load cup assembly 148. The input buffer station 142 receives substrates from the factory interface 102 by means of the loading robot 104. The loading robot 104 is also utilized to return polished substrates from the output buffer station 144 to the factory interface 102. The transfer robot 146 is utilized to move substrates between the buffer stations 142, 144 and the load cup assembly 148.

In one embodiment, the transfer robot 146 includes two gripper assemblies (not shown), each having pneumatic gripper fingers that hold the substrate by the substrate's edge. The transfer robot 146 may simultaneously transfer a substrate to be processed from the input buffer station 142 to the load cup assembly 148 while transferring a processed substrate from the load cup assembly 148 to the output buffer station 144. An example of a transfer station that may be used to advantage is described in U.S. Pat. No. 6,156,124, issued Dec. 5, 2000 to Tobin, which is herein incorporated by reference in its entirety.

The carousel 134 is centrally disposed on the base 140. The carousel 134 typically includes a plurality of arms 150, each supporting a planarizing head assembly 152. Two of the arms 150 depicted in FIG. 2 are shown in phantom such that the transfer station 136 and a polishing article assembly 126 of the first Ecmp station 128 may be seen. The carousel 134 is indexable such that the planarizing head assemblies 152 may be moved between the planarizing stations 128, 130, 132 and the transfer station 136. One carousel that may be utilized to advantage is described in U.S. Pat. No. 5,804,507, issued Sep. 8, 1998 to Perlov, et al., which is hereby incorporated by reference in its entirety.

A conditioning device 182 is disposed on the base 140 adjacent each of the planarizing stations 128, 130, 132. The conditioning device 182 periodically conditions the planarizing material disposed in the stations 128, 130, 132 to maintain uniform planarizing results.

Electrochemical Mechanical Processing

Methods and compositions are provided for polishing a substrate to remove conductive materials including residues, and minimize dishing within features, while increasing throughput with a decrease in polishing time. The methods may be performed by an electrochemical polishing technique. In one aspect, the method may include processing a substrate having a conductive material layer disposed over features, supplying a polishing composition as described herein to the surface of the substrate, applying a pressure between the substrate and a polishing article, providing relative motion between the substrate and the polishing article, applying a bias between a first electrode and a second electrode in electrical contact with the substrate, and removing at least a portion of the conductive material from the substrate surface.

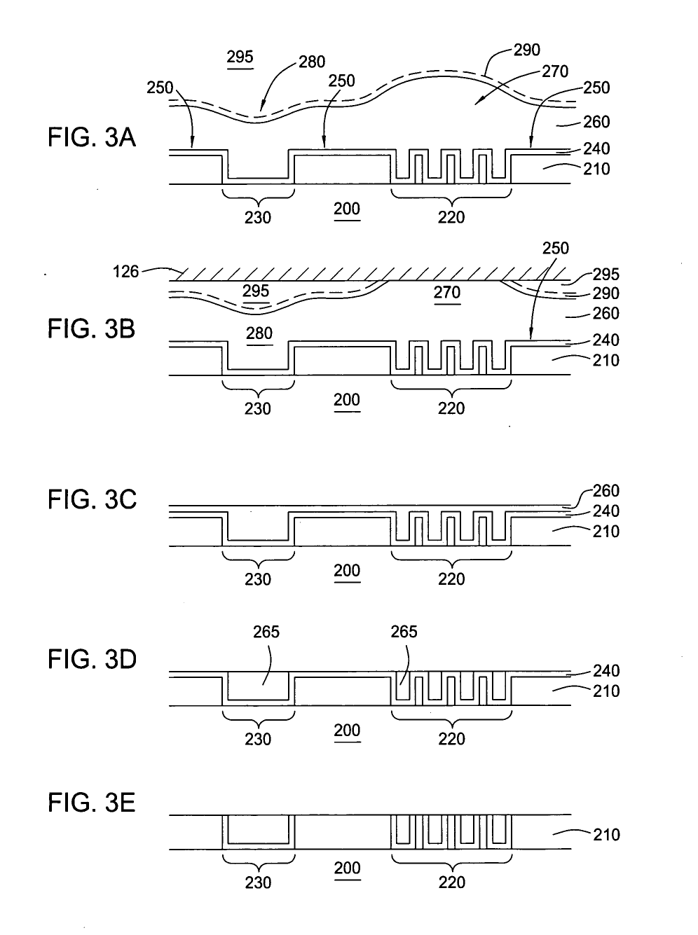

One embodiment of the process will now be described in reference to FIGS. 3A-3E, which are schematic cross-sectional views of a substrate being processed according to methods and compositions described herein. Referring to FIG. 3A, a substrate generally includes a dielectric layer 210 formed on a substrate 200. A plurality of apertures, such as vias, trenches, contacts, or holes, are patterned and etched into the dielectric layer 210, such as a dense array of narrow feature definitions 220 and low density of wide feature definitions 230. The apertures may be formed in the dielectric layer 210 by conventional photolithographic and etching techniques.

FIG. 3A depicts a substrate 200 and a conductive material 260 with a passivation layer 290 formed thereon before an Ecmp process has been applied. FIG. 3B illustrates the contact of the substrate surface with a polishing article to remove a portion of the passivation layer 290 formed thereon. FIG. 3C illustrates the substrate after a portion of the conductive material 260, such as at least about 50% of the conductive material 260, has been removed by applying a first Ecmp process. The remaining conductive material 260 or residual material disposed upon a barrier layer 240 is removed to the barrier layer 240 by applying a second Ecmp process, as illustrated in FIG. 3D. Furthermore, as illustrated in FIG. 3E, the remaining barrier layer 240 on the dielectric layer 210 may be removed by a third process, such as a CMP process or a third Ecmp process. Alternatively, and not shown, the remaining conductive material 260 and the barrier layer 240 may be removed in a single processing step.

The terms narrow and wide feature definitions may vary depending on the structures formed on the substrate surface, but can generally be characterized by the respective deposition profiles of excessive material deposition (or high overburden) formed over narrow feature definitions and minimal or low material deposition (minimal or low overburden), over wide feature definitions. For example narrow feature definitions may be about 0.13 μm in size and may have a high overburden as compared to wide feature definitions that may be about 10 μm in size and that may have minimal or insufficient overburden. However, high overburdens and low overburdens do not necessarily have to form over features, but may form over areas on the substrate surface between features.

The dielectric layer 210 may comprise one or more dielectric materials conventionally employed in the manufacture of semiconductor devices. For example, dielectric materials may include materials such as silicon dioxide, phosphorus-doped silicon glass (PSG), boron-phosphorus-doped silicon glass (BPSG), and silicon dioxide derived from tetraethyl orthosilicate (TEOS) or silane by plasma enhanced chemical vapor deposition (PECVD). The dielectric layer may also comprise low dielectric constant materials, including fluoro-silicon glass (FSG), polymers, such as polyamides, carbon-containing silicon oxides, such as BLACK DIAMOND™ dielectric material, silicon carbide materials, which may be doped with nitrogen and/or oxygen, including BLOK™ dielectric materials, available from Applied Materials, Inc. of Santa Clara, Calif.

A barrier layer 240 is disposed conformally in the feature definitions 220 and 230 and on the substrate 200. The barrier layer 240 may comprise metals or metal nitrides, such as tantalum, tantalum nitride, tantalum silicon nitride, titanium, titanium nitride, titanium silicon nitride, tungsten, tungsten nitride or combinations thereof, or any other material that may limit diffusion of materials between the substrate and/or dielectric materials and any subsequently deposited conductive materials.

A layer of conductive material 260 is disposed on the barrier layer 240. The term “conductive material layer” as used herein is defined as any conductive material, such as copper, tungsten, aluminum, silver or an alloy thereof, used to fill a feature to form lines, contacts or vias. While not shown, a seed layer of a conductive material may be deposited on the barrier layer prior to the deposition of the conductive material 260 to improve interlayer adhesion and improve subsequent deposition processes. The seed layer may be of the same material as the subsequent material to be deposited.

One type of conductive material 260 comprises copper containing materials. Copper containing materials include copper, copper alloys (e.g., copper-based alloys containing at least about 80 weight percent copper) or doped copper. As used throughout this disclosure, the phrase “copper containing material,” the word “copper,” and the symbol “Cu” are intended to encompass copper, copper alloys, doped copper, or combinations thereof. Additionally, the conductive material may comprise any conductive material used in semiconductor manufacturing processing.

Although the polishing compositions are particularly useful for removing copper, it is believed that the polishing compositions also may be used for the removal of other conductive materials, such as aluminum, platinum, tungsten, tungsten nitride titanium, titanium nitride, tantalum, tantalum nitride, cobalt, gold, silver, ruthenium or combinations thereof. Mechanical abrasion, such as from contact with the conductive polishing article may be used with the polishing composition to improve planarity and improve removal rate of these conductive materials.

In one embodiment, the deposited conductive material 260 has a deposition profile of excessive material deposition or high overburden 270, also referred to as a hill or peak, formed over narrow feature definitions 220 and minimal overburden 280, also referred to as a valley, over wide feature definitions 230. In another embodiment, high overburdens and minimal overburdens are arbitrarily formed across the substrate surface between features.

A first electrochemical mechanical polishing (Ecmp) process may be used to remove a first portion of the conductive material, bulk conductive material, from the substrate surface as shown from FIGS. 3B-3C and then a second Ecmp process to remove a second portion of conductive material, residual copper containing material, as shown from FIGS. 3C-3D.

An electrochemical mechanical polishing technique using a combination of chemical activity, mechanical activity and electrical activity to remove material and planarize a substrate surface. Bulk material is broadly defined herein as any material deposited on the substrate in an amount more than sufficient to substantially fill features formed on the substrate surface. Residual material, or residue material, is broadly defined as any bulk material remaining after one or more polishing process steps. Generally, the bulk removal during a first Ecmp process removes at least about 50% of the conductive layer, preferably at least about 70%, more preferably at least about 80%, for example, at least about 90%. The residual removal during a second Ecmp process removes most, if not all the remaining conductive material disposed on the barrier layer to leave behind the filled plugs. In an alternative embodiment of the Ecmp process, the entire conductive material may be removed from the substrate surface in a single processing step.

The first Ecmp process attributes to the throughput of substrate manufacturing due to a fast removal rate of the conductive layer. However, if the first Ecmp process is used solely, too much conductive material may be removed to produce an under burden. The second Ecmp process attributes to the throughput of substrate manufacturing due to the precise removal the conductive layer to form level substrate surfaces. Therefore, the combined first and second Ecmp processes increases throughput and produces high quality planar substrate surfaces.

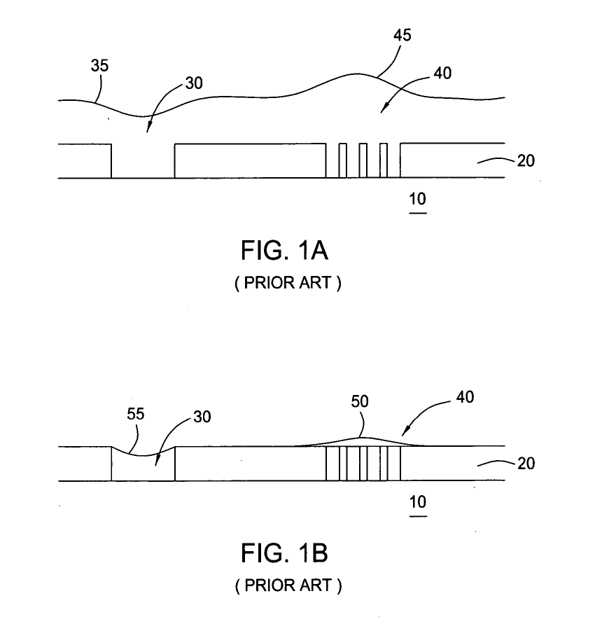

Additionally, the first Ecmp process produces a fast removal rate of the conductive material layer and the second Ecmp process, due to the precise removal of the remaining conductive material, forms level substrate surfaces with reduced or minimal dishing and erosion of substrate features. The Ecmp or CMP barrier removal process also forms level substrate surfaces with reduced or minimal dishing and erosion of substrate features. The second Ecmp step is slower in order to prevent excess metal removal from forming topographical defects, such as concavities or depressions known as dishing D, as shown in FIG. 1A, and erosion E as shown in FIG. 1B. Therefore, a majority of the conductive material 260 is removed at a faster rate during the first Ecmp step than the remaining or residual conductive material 260 during the second Ecmp step. This Ecmp process increases throughput of the total substrate processing while producing a smooth surface with little or no defects.

The removal of the first portion of conductive material, the bulk removal, Ecmp process may be performed on a first polishing platen and the second portion of the conductive material, the residual removal Ecmp process on a second polishing platen of the same or different polishing apparatus as the first platen. In another embodiment, the residual removal Ecmp process may be performed on the first platen. Any barrier material may be removed on a separate platen, such as the third platen. For example, an apparatus in accordance with the processes described herein may include three platens for removing bulk material or comprise one platen to remove bulk material, a second platen for residual removal and a third platen for barrier removal, wherein the bulk and the residual processes are Ecmp processes and the barrier removal is a CMP process. In another embodiment, three Ecmp platens may be used to remove bulk material, residual removal and barrier removal.

In one embodiment of an electrochemical mechanical polishing technique, the substrate is disposed in a receptacle, such as a carrier head and positioned adjacent a platen having polishing article coupled to a polishing article assembly containing a first and second electrode. The substrate is then disposed in the platen and physically contacted with the polishing article and the substrate is electrically coupled with at least one electrodes through the polishing article and a polishing composition. The polishing composition is also disposed on the platen between the pad assembly and the substrate. The polishing composition forms a passivation layer on the substrate surface. The passivation layer may chemically and/or electrically insulate material disposed on a substrate surface. Relative motion is provided between the substrate surface and the conductive article to reduce or remove the passivation layer. A bias from a power source is applied between the two electrodes.

In general, the application of the bias may be used to dissolve or remove conductive material, such as copper-containing or tungsten-containing materials, formed on a substrate surface by anodic dissolution. The power applied may include a current density up to about 100 milliamps/centimeter squared (mA/cm²) which correlates to an applied current of up to about 40 amps to process substrates with a diameter up to about 300 mm. For example, a 200 mm diameter substrate may have a current density from about 0.01 mA/cm² to about 50 mA/cm², which correlates to an applied current from about 0.01 A to about 20 A. The invention also contemplates that the bias may be applied and monitored by volts, amps and watts. In one embodiment, a power supply is used to apply a bias at a power level between about 0.1 Watts and 100 Watts, a voltage between about 0.1 V and about 10 V, and a current between about 0.1 amps and about 20 amps. However, the particular operating specifications of the power supply may vary according to application.

The first, bulk, and second, residual, conductive material removal Ecmp steps may be controlled by the application of power during the respective process. In one embodiment of a bulk and residual removal process, the applied biases to the respective steps include applying a DC bias to the bulk removal process and at least a pulse bias during at least a portion of the residual removal process. The DC bias may include a DC voltage, also referred to as a constant voltage bias, and the pulse bias may comprise a time varying voltage bias. The voltages applied during the residual removal process may be equal to or less than voltages applied during the bulk removal processes. The voltages applied during the residual removal process may be equal to or greater than voltages applied during the bulk removal processes. Alternatively, the pulse bias of the residual removal process may have maximums and minimum respectively greater than or lesser than the DC voltages applied during the bulk removal process.

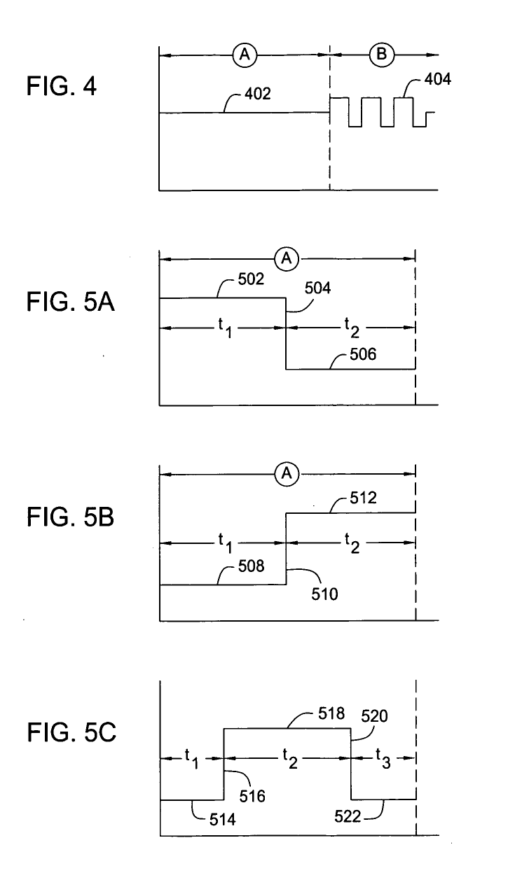

FIG. 4 illustrates voltage application during the first and second Ecmp processes. While FIG. 4 illustrates a continual voltage application process that may be performed on a single platen, the invention contemplates that the voltage application may occur on two or more platens, for example, a bulk removal on a first platen and a residual removal on a second platen. Therefore, FIG. 4 is illustrative and should not be construed or interpreted as limiting the scope of the invention.

Portion A of FIG. 4 indicates the voltage application 402 for the bulk conductive material removal process (bulk removal process). The bulk removal process is a direct current (DC) voltage application. The DC voltage may be applied at a constant voltage with the constant voltage being between about 0.5 V and about 4.5 V. The individual voltage may vary based on the electrical properties of the polishing composition.

The DC voltage may include a critical voltage and voltages on either side of the critical voltage. The critical voltage is located between the active corrosion state voltage and the passive corrosion state voltage. At the active corrosion state voltage, the metal layer oxidizes into metal ions (corrodes) and removes material from the substrate surface and includes the voltage less than the critical voltage. At the passive state voltage, the metal layer forms a metal oxide layer, which may add to or form a passivation layer, and removal of material from the substrate surface is minimal, which voltage is greater than the critical voltage. The critical voltage represents the upper voltage limit for the active state and the lower voltage limit for the passive state. The critical voltage may vary in each process, and is generally proportional to the pH of the electrolyte chemistry, and, the critical voltage will either rise or fall proportionally with the pH. For example, if the pH of the polishing composition is higher, the critical voltage will increase proportionally

The DC voltage of the bulk removal process may be applied in a step-wise fashion. FIG. 5A illustrate applying a first constant voltage 502 for a first period of time t₁ and the step-wise decreasing 504 the DC voltage to a second constant voltage 506 for a second period of time t₂ before ending the bulk removal process or beginning the residual removal process. FIG. 5B illustrates a second embodiment of the DC step-wise voltage application including a first constant voltage 508 for a first period of time t₁ that is increased 510 to a second constant voltage 512 greater than the first DC voltage 508 for a second period of time t₂. FIG. 5C illustrate a third embodiment of the step wise DC voltage application including a first constant voltage 514 for a first period of time t₁ that is step wise increased 516 to a second constant voltage 518 greater than the first constant voltage 508 for a second period of time t₂ that is step-wise decreased 520 to a third constant voltage 522 less than the second constant voltage 518 for third t₃ period of time. The third constant voltage 522 may be less than, equal to, or greater than the first DC voltage 514.

For the above embodiments in FIGS. 5A-5C, the DC voltage applications may be in only the active corrosion state voltage range or the passive corrosion state voltage range cross the critical voltage of the process or, alternatively, the applied voltage in the step-wise embodiments, be in both the active corrosion state voltage range or the passive corrosion state voltage range.

Section B of FIG. 4 indicates the voltage application 404 for the residual conductive material removal Ecmp process (the residual removal process). The residual removal process includes at least a portion of voltage application as a pulse bias application. Additionally, the residual removal process may include DC voltage application before or after pulse bias applications. The DC voltage application may also occur intermittently between pulse bias applications, such as in the voltage application series of DC voltage application, pulse voltage application, DC voltage application, pulse voltage application, and then DC voltage application.

The pulse voltage may be applied between about 0.1 V and about 3 V. The individual pulse voltage difference may vary, for example, the pulse may vary between 0.001 volts and about 3 volts between the respective maximum and minimum voltages of the pulse. Each minimum and maximum voltage application of the pulse may have a duration of between about 0.01 second and about 20 seconds. The bias of the pulse may also include the active state corrosion voltage, the passive state corrosion voltage, or both. The pulse voltage may vary based on the electrical properties of the polishing composition. The bias may be varied in power and application depending upon the user requirements in removing material from the substrate surface. For example, increasing power application has been observed to result in increasing anodic dissolution.

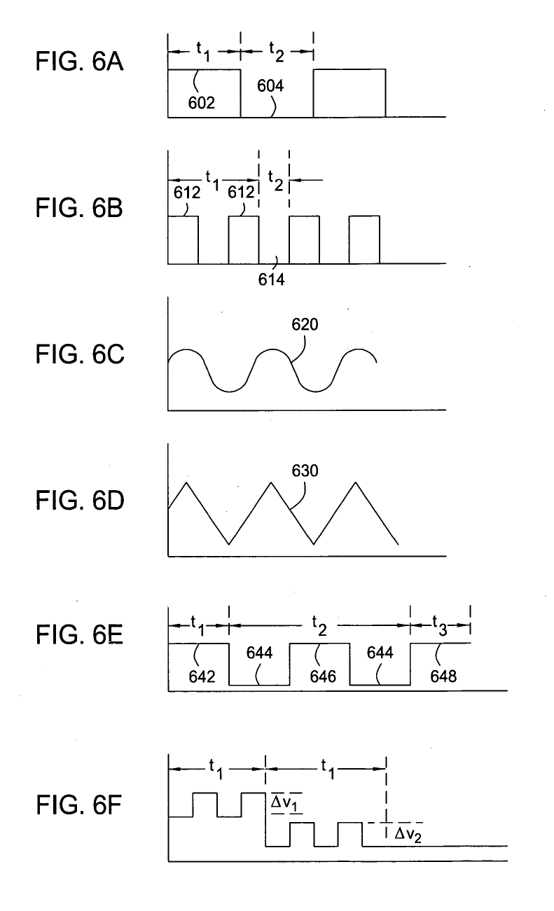

FIG. 6A illustrates one version of the pulse bias for the residual polishing step that includes a time-varying voltage signal from a pulse modulation technique applied to the substrate through the polishing article. Pulse modulation techniques may vary, but generally include a cycle of applying a constant current density or voltage for a first period of time, and then applying a constant current density or voltage for a second period of time with the second voltage being different that the first voltage. The second voltage may have a positive polarity like the first voltage second period of time, may have no current density or voltage second period of time, or the second voltage may have a constant reverse current density or voltage for a second period of time. The pulse modulation technique may then be repeated for a plurality of cycles, which may also have varying power levels and durations.

For example, in FIG. 6A, a first, constant voltage signal 602 may initially be applied for a first time period t₁, followed by a second, zero voltage signal 604 for a second time period t₂, which may then be repeated for any number of cycles as determined by the operator. The voltage signal 602 may range from about 0.5 V to about 3 V for the first time period t₁ between 0.01 seconds and about 20 seconds, and the second voltage signal 604 has a voltage of zero for a time period t₂ that may range between about 0.01 seconds and about 20 seconds.

Alternatively, the second voltage is a voltage greater than 0.01 and less than the first voltage signal 602, for example, between 0.01 V and less than about 0.5 V. In another embodiment, the second voltage may be a negative voltage, for example, between about −0.01 and about −3V. Thus, the invention contemplates pulse bias at positive voltages and pulse bias including positive and negative voltages. Additionally, the pulse bias may have a minimum voltage less than or equal to a prior applied DC voltage. The pulse bias may also have a maximum voltage greater than or equal to a prior applied DC voltage.

Each of the first and second voltages may also include a time-varying voltage signal having a waveform. A square waveform is illustrated in FIGS. 6A-6B and 6E-6F, however, the invention contemplates other types of waveforms, for example, a sinusoidal waveform 620 as shown in FIG. 6C and a sawtooth waveform 622 as shown in FIG. 6D, among others. If waveforms of variable voltages are used as shown in FIGS. 6C and 6D, the voltage of the waveform is the average value of the voltage over the duration of the waveform. The power levels, the duration of power and no power (zero voltage), and frequency of cycles, and waveform patterns may be modified based on the removal rate, materials to be removed, and the extent of the polishing process. Alternatively, the DC bias may have a waveform.

FIG. 6E illustrates another embodiment of bias application in the residual polishing process with the application of an initial DC bias followed by a pulse bias. A first constant voltage 642 is applied for a first period of time t₁, and then a pulse bias having a minimum voltage 644 and a maximum voltage 646 is applied for a second period of time t₂. Optionally or alternatively, and shown in FIG. 6E, a second constant voltage 648 may be applied for a third period of time t₃ after the pulse bias for continuing the residual polishing process. Alternatively, a bias application may include only the pulse bias followed by a DC bias as described by second constant voltage 648. A cycle of a DC voltage and a pulse voltage may be repeated one or more time during the residual polishing process. The invention contemplates that multiple pulse bias processes may be performed based on desired polishing effects of the process.

FIG. 6F illustrates another embodiment in which the pulse bias voltage ranges may be varied with duration during processing. A first pulse voltage signal 650 is applied for a first time period t₁, and then a second pulse voltage signal 660 is applied or a second period of time t₂. The first pulse voltage signal 650 may be within a first voltage range (Δ_{V1}), and the second pulse voltage signal 660 may be in a second range (Δ_{V2}). Such a pulse voltage signal pattern may have a single cycle or any number of cycles and may occur in one or more of the respective pulse biases applied during a residual removal process.

Referring back to FIG. 3A, the Ecmp process begins by positioning the substrate in a polishing apparatus and exposed to a polishing composition 295 that can form a passivation layer 290 on the conductive material layer. The passivation layer may be formed by the polishing compositions described herein.

The substrate is exposed to a polishing composition described herein that forms a passivation layer 290 on the conductive material 260. The passivation layer 290 forms on the exposed conductive material 260 on the substrate surface including the high overburden 270, peaks, and minimal overburden 280, valleys, formed in the deposited conductive material 260. The passivation layer 290 chemically and/or electrically insulates the surface of the substrate from chemical and/or electrical reactions. The passivation layer is formed from the exposure of the substrate surface to the corrosion inhibitor and/or other materials capable of forming a passivating or insulating film, for example, chelating agents. The thickness and density of the passivation layer can dictate the extent of chemical reactions and/or amount of anodic dissolution. For example, a thicker or denser passivation layer 290 has been observed to result in less anodic dissolution compared to thinner and less dense passivation layers. Thus, control of the composition of passivating agents, corrosion inhibitors and/or chelating agents, allow control of the removal rate and amount of material removed from the substrate surface.

Ecmp compositions may be used to remove bulk material and residual material, such as copper and/or copper alloys, as well as to remove barrier materials, such as tantalum nitrides or titanium nitrides. Specific formulations of the polishing compositions are used to remove the particular materials. Polishing compositions utilized during embodiments herein are advantageous for Ecmp processes. Generally, Ecmp solutions are much more conductive than traditional CMP solutions. The Ecmp solutions have a conductivity of about 10 mS/cm or higher, while traditional CMP solutions have a conductivity from about 3 mS/cm to about 5 mS/cm. The conductivity of the Ecmp solutions greatly influences that rate at which the Ecmp process advances, i.e., more conductive solutions have a faster material removal rate. The compositions formed herein may generally have a conductivity between about 10 mS/cm and about 80 mS, such as between about 30 mS/cm and about 50 mS, for example, about 40 mS/cm. The composition may be adjusted in conductivity based on the process being performed. For removing bulk material, the Ecmp solution has a conductivity of about 10 mS/cm or higher, preferably in a range from about 30 mS/cm to about 60 mS/cm. For residual material, the Ecmp solution has a conductivity of about 10 mS/cm or higher, preferably in a range from about 15 mS/cm to about 40 mS/cm.

An example of a composition that may be used for the first Ecmp processing step as shown in FIGS. 3B-3C includes a composition of between about 1 wt. % and about 20 wt. % of the acid based electrolyte system, between about 0.05 wt. % and about 0.6 wt. % of the corrosion inhibitors having an azole group, between about 0.2 wt. % and about 6 wt. % of the organic acid salt, between about 0.5 vol. % and about 6 vol. % of the pH adjusting agents to provide a pH between about 4 and less than about 7. In a further example, the composition may include between about 4 wt. % and about 15 wt % of an acid based electrolyte, such as between about 8 wt. % and about 12 wt. % of phosphoric acid or 85% phosphoric acid aqueous solution, between about 0.2 wt. % and about 6 wt. % of a chelating agent, such as between about 0.4 wt. % and about 3 wt. % of ammonium citrate tribasic and/or amino hydrogen citrate, between about 0.05 wt. % and about 0.6 wt. % of a corrosion inhibitor, such as benzotriazole (BTA), and a pH adjuster, such as ammonium hydroxide and/or potassium hydroxide to form a pH level between about 3 and about 9, for example between about 4 and about 7, and alternatively, the composition may include between about 0.01 wt. % and about 2 wt. % of abrasive particles. Suitable examples of a polishing composition for the bulk removal are further described in U.S. patent application Ser. No. ______, filed on Feb. ______, 2006, entitled “Method and Composition for Polishing a Substrate” [Attorney Docket Number 010788/PPC/CMP/CKIM], which application is incorporated herein to the extent not inconsistent with the claims aspects and description herein.

Further examples of suitable polishing composition for bulk removal are disclosed in U.S. patent application Ser. No. 10/608,404, filed on Jun. 26, 2003, U.S. patent application Ser. No. 10/845,754, filed on May 15, 2004, U.S. patent application Ser. No. 11/196,876, filed on Aug. 4, 2005, U.S. patent application Ser. No. 11/251,630, filed on Oct. 14, 2005, and U.S. patent application Ser. No. 11/312,823, filed on Dec. 19, 2005, which applications are incorporated herein to the extent not inconsistent with the claims aspects and description herein.

FIG. 3B illustrates electrochemical mechanical polishing during processing. During processing, the substrate surface and a polishing article, such as conductive polishing article disposed in the polishing article assembly 126, are contacted with one another and moved in relative motion to one another, such as in a relative orbital motion, to remove portions of the passivation layer 290 formed on the exposed conductive material 260, which contact may additionally also remove a portion of the underlying conductive material 260.

The substrate surface and polishing article are contacted at a pressure less than about 2 pounds per square inch (lb/in² or psi) (13.8 kPa). Removal of the passivation layer 290 and some conductive material 260 may be performed with a process having a pressure of about 1 psi (6.9 kPa) or less, for example, from about 0.01 psi (69 Pa) to about 0.5 psi (3.4 kPa). In one aspect of the process, the substrate surface and polishing article are contacted at a pressure of about 0.2 psi (1.4 kPa) or less.

The polishing pressures used herein reduce or minimize damaging shear forces and frictional forces for substrates containing low k dielectric materials. Reduced or minimized forces can result in reduced or minimal deformations and defect formation of features from polishing. Further, the lower shear forces and frictional forces have been observed to reduce or minimize formation of topographical defects, such as dishing and scratches, and delamination, during polishing. Contact between the substrate and a conductive polishing article also allows for electrical contact between the power source and the substrate by coupling the power source to the polishing article when contacting the substrate. A region of non-passivated material may be exposed and removed by anodic dissolution by mechanical abrasion to disturb or remove the passivation layer on the surface of the substrate.

Mechanical abrasion by a conductive polishing article removes the passivation layer that insulates or suppresses the current for anodic dissolution, such that areas of high overburden is preferentially removed over areas of minimal overburden as the passivation layer is retained in areas of minimal or no contact with the conductive polishing article. The removal rate of the conductive material 260 covered by the passivation layer is less than the removal rate of conductive material without the passivation layer. As such, the excess material disposed over narrow feature definitions 220 and the substrate field 250 is removed at a higher rate than over wide feature definitions 230 still covered by the passivation layer 290.

In one embodiment the platen is rotated at a velocity from about 3 rpm (rotations per minute) to about 100 rpm, and the polishing head is rotated at a velocity from about 5 rpm to about 200 rpm and also moved linearly at a velocity from about 5 cm/s (centimeters per second) to about 25 cm/s in a direction radial to the platen. The preferred ranges for a 200 mm diameter substrate are a platen rotational velocity from about 5 rpm to about 40 rpm and a polishing head rotational velocity from about 7 rpm to about 100 rpm and a linear (e.g., radial) velocity of about 10 cm/s. The preferred ranges for a 300 mm diameter substrate are a platen rotational velocity from about 5 rpm to about 20 rpm and a polishing head rotational velocity from about 7 rpm to about 50 rpm and a linear (e.g., radial) velocity of about 10 cm/s. In one embodiment of the present invention the platen has a diameter between about 17 inches (43.2 cm) and about 30 inches (76.2 cm).

The polishing head may move along the radius of the platen for a distance between about 0.1 inches (2.5 mm) and about 2 inches (5.1 cm). The carrier head rotational speed may be greater than a platen rotational speed by a ratio of carrier head rotational speed to platen rotational speed of greater than about 1:1, such as a ratio of carrier head rotational speed to platen rotational speed between about 1.5:1 and about 12:1, for example between about 1.5:1 and about 3:1, to remove material from the substrate surface.

A bias is applied to the substrate during contact between the substrate surface and the conductive polishing article for anodic dissolution of the conductive material 260 from the substrate surface. In the first Ecmp step for bulk removal processing, the bias may be applied as described herein and shown in FIGS. 4 and 5A-5C.

The endpoint of the bulk polishing process may be determined by electric charge, time or thickness measurements. For example, the endpoint was determined using the total accumulated charge method. The endpoints are pre-determined by a pre-measurement of incoming wafer thickness and a software algorithm. The software algorithm determines how much charge is removed from each spot on the wafer surface and the charge is correlated to the wafer thickness. The charge is proportional to the total amount of material removed from the wafer. Since the area of the wafer is known, the accumulated charge is in turn proportional to the thickness of the material removed. Endpoint detection methods are discussed in U.S. patent application Ser. No. 10/949,160 entitled “Endpoint Compensation In Electroprocessing,” filed Sep. 24, 2004, which is incorporated by reference herein to the extent not inconsistent with the claimed aspects and disclosure herein. Other endpoint detection methods known in the art can also be used including eddy currents and interferometers. The first endpoint represents the end of the bulk polish step described herein with reference to FIGS. 3B-3C. Prior to the endpoint, continuous voltage is applied during the bulk removal step. When the first endpoint is reached, the bulk polish step ends and the residual polishing step begins.

A removal rate of conductive material of up to about 15,000 Å/min can be achieved by the processes described herein. Higher removal rates are generally desirable, but due to the goal of maximizing process uniformity and other process variables (e.g., reaction kinetics at the anode and cathode) it is common for dissolution rates to be controlled from about 100 Å/min to about 15,000 Å/min. In one embodiment of the invention where the copper material to be removed is less than 5,000 Å thick, the voltage (or current) may be applied to provide a removal rate from about 100 Å/min to about 5,000 Å/min. The substrate is typically exposed to the polishing composition and power application for a period of time sufficient to remove at least a portion or all of the desired material disposed thereon.

While not shown, the first bulk polishing step may result in a protrusion of conductive material 260 formed over the wide features. The protrusion is formed from material that was unpolished or polished at a reduced removal rate due to the formation of a thicker or more dense passivation layer or for longer durations than other portions of the conductive material 260. For example, the protrusion may be up to about 50% of the deposited conductive material thickness, such as between about 1% and about 40% of the deposited conductive material thickness. The processes described herein have been observed herein to produce a protrusion between about 20% and about 30% of the deposited material thickness.

The amount or size of the protrusion may be controlled, for example, by varying the chemistry used in the process, the power application, such as power levels, and pulse modulation technique. The invention contemplates that the compositions described herein and the power applications described herein may be varied beyond the illustrative examples detailed herein to achieve the formation of a protrusion herein and/or the relative removal rates over wide and narrow feature definitions. For example, a pulse bias application is believed to enhance passivation of deposited materials, and increased protrusion has been observed to occur with increase pulse bias application.

In one embodiment of the Ecmp process, the removal rate of conductive material 260 is much faster during the first Ecmp process step than during the second Ecmp process step. For example, the first Ecmp process removes conductive material 260 at a rate from about 1,000 Å/min to about 15,000 Å/min as indicated herein, while the second Ecmp process removes conductive material 260 at a rate from about 100 Å/min to about 8,000 Å/min. The second Ecmp process is slower in order to prevent excess metal removal to form topographical defects, such as concavities or depressions known as dishing 55, as shown in FIG. 1B. Therefore, a majority of the conductive material 260 is removed at a faster rate during the first Ecmp process than the remaining conductive material 260 during the second Ecmp process. The two-step Ecmp process increases throughput of the total substrate processing and while producing a smooth surface with little or no defects.

FIG. 3C illustrates that at least about 50% of the conductive material 260 was removed after the bulk removal of the first Ecmp process, for example, about 90%. After the first Ecmp process, conductive material 260 may still include the high overburden 270, peaks, and/or minimal overburden 280, valleys, but with a reduced proportionally size. However, conductive material 260 may also be rather planar across the substrate surface (not shown).

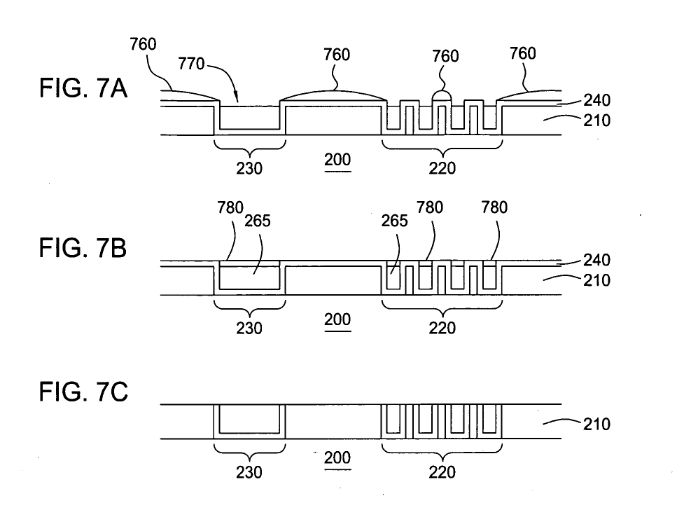

Referring to FIG. 3D, most, if not all of the conductive material 260 is removed to expose barrier layer 240 and conductive trenches 265 by polishing the substrate with a second Ecmp process for residual removal processing including a second Ecmp polishing composition. The conductive trenches 265 are formed by the remaining conductive material 260. An alternate conductive material 260/barrier layer 240 removal process is shown in FIGS. 7A-7C herein.

FIGS. 3C-3D illustrates electrochemical mechanical polishing during processing of the residual conductive material. The electrochemical mechanical polishing process or residual removal includes having the substrate surface and a polishing article, such as conductive polishing article disposed in the polishing article assembly 126, are contacted with one another and moved in relative motion to one another, such as in a relative orbital motion, and to remove any portions of the optional passivation layers that may formed on the exposed conductive material 260, which contact may additionally also remove a portion of the underlying conductive material 260. Contact between the substrate and a conductive polishing article also allows for electrical contact between the power source and the substrate by coupling the power source to the polishing article when contacting the substrate.

The second polishing step may be performed under the processing parameters described herein for the first polishing step with the addition of the residual removal bias application as described herein.

Additionally, any suitable Ecmp composition useful for removing residual conductive material may be used in the second Ecmp processing step. The second composition may comprise the first composition as described above for the first polishing step for bulk removal. One example of a suitable polishing composition for the second polishing step is disclosed in commonly assigned and co-pending U.S. Ser. No. 11/123,274, filed May 5, 2005, and published as US 20050218010, which is incorporated herein to the extent not inconsistent with the claims aspects and disclosure herein. Further examples of suitable polishing composition for residual removal are disclosed in U.S. patent application Ser. No. 10/845,754, filed on May 15, 2004, U.S. patent application Ser. No. 11/196,876, filed on Aug. 4, 2005, U.S. patent application Ser. No. 11/251,630, filed on Oct. 14, 2005, and U.S. patent application Ser. No. 11/312,823, filed on Dec. 19, 2005, which applications are incorporated herein to the extent not inconsistent with the claims aspects and description herein.

A residual removal bias is applied to the substrate during contact between the substrate surface and the conductive polishing article for anodic dissolution of the conductive material 260 from the substrate surface. In the second Ecmp step for residual removal processing, the bias may be applied as described herein and shown in FIGS. 4 and 6A-6F.

In one example of the bias application, each pulse of the one or more pulses lasts for a time period of approximately 4 seconds (time period can be varied depending on the film thickness and electrochemical properties). Also, the time period for each voltage does not have to be the same. The low voltage is approximately in a range between about 1.0 V and about 2.0 V, for example about 1.8 V. The high voltage is approximately in a range between about 2.0 V and about 3.5 V, for example about 2.5 V. The pulses may be primarily above the critical voltage for the time period between the endpoint of the bulk removal process and the endpoint of the residual polishing process. Thus this residual polish step occurs primarily in the passive state and in order to keep removing conductive material the pulse voltage moves down into the active state for short time periods. This residual clearance stage will generally have a 20-50% duty cycle of voltage below the critical voltage in regard to the voltage above the critical voltage. After the second endpoint is reached, a timed overpolish may be performed.

Other embodiments of the invention contemplate adjusting the duty cycle between high and low voltage to increase the ratio of high voltage to low voltage as the residual polish endpoint is approached. This increases the ratio of passive state to active state thus slowing the residual polishing rate as the endpoint is approached. In another embodiment, a second critical voltage is used. This second critical voltage occurs at a high voltage. Above this second critical voltage is another active state and below the second critical voltage is the passive state. This second critical voltage can be used similarly to the first critical voltage discussed above.

During a pulse bias application, it is believed that the metal ions migrate and interact with the corrosion inhibitors and/or chelating agents by attaching to the passivation layer in the non-mechanically disturbed areas. The process thus allows etching in the electrochemically active regions, not covered by the passivation layer, during an bias application, and then allowing reformation of the passivation layer in some regions and removal of excess material during an minimal or no bias application in other regions. Thus, control of the pulse bias application can control the removal rate and amount of material removed from the substrate surface.

One example of a pulse modulation process is described in commonly assigned U.S. Pat. No. 6,379,223, which is incorporated by reference herein to the extent not inconsistent with the claimed aspects and disclosure herein. Further examples of a pulse modulation process is described in co-pending U.S. Ser. No. 10/611,805, entitled “Effective Method To Improve Surface Finish In Electrochemically Assisted Chemical Mechanical Polishing,” filed on Jun. 30, 2003, which is incorporated by reference herein to the extent not inconsistent with the claimed aspects and disclosure herein.

Alternatively, an overpolish process may be used prior to a barrier polishing process. The overpolish process allows for continuing the process after an endpoint has been determine to ensure removal of residual materials. The overpolish may be performed under the same conditions as the residual removal process. Alternatively, the overpolish process may occur with the same processing paramaters including DC bias as the first Ecmp processing step.

Alternatively, the conductive material 260 may be removed to the barrier layer as shown in FIG. 3D is a single Ecmp polishing step with the polishing composition disclosed herein by the processing parameters described herein.

The barrier material, and alternatively, any further residual conductive material, may then be polished by a third polishing step to provide a planarized substrate surface containing conductive trenches 265, as depicted in FIG. 3E. The residual conductive material and barrier material may be removed by a third polishing process, such as a third Ecmp process or a CMP process. Examples of barrier polishing processes are disclosed in commonly assigned and co-pending U.S. Ser. No. 10/193,810, filed Jul. 11, 2002, and published as US 20030013306, and U.S. Ser. No. 11/130,032, filed May 16, 2005, and published as US 2005-0233578, which are both incorporated herein to the extent not inconsistent with the claims aspects and disclosure herein.

Referring to FIGS. 7A-7C, in a second embodiment of the Ecmp bulk and residual polishing process. The conductive material 260 is removed in the same fashion as described in FIGS. 3A-3C with the conductive material 260 removed to the extent of forming recessed areas 770 in the feature definitions 220, 230 as shown in FIG. 7A. Some conductive material 260 may be remaining as residual material 760 on the fields of the substrate as shown in FIG. 7A. A pulse bias application as described herein for residual material removal above is then applied, for example, as shown in FIG. 6E. In another bias application embodiment for removal of residual material 760 in FIGS. 7A-7B, the application includes a pulse bias followed by a DC bias. The pulse bias is believed to passivate and protect the recessed areas as shown as passivation layer 780, and then when the DC bias application is resumed, the residual material 760 may be removed with reduced or minimal removal from the passivated, recessed areas. After residual removal material, the barrier layer may be removed as shown in FIG. 7C.

After conductive material and barrier material removal processing steps, the substrate may then be buffed to minimize surface defects. Buffing may be performed with a soft polishing article, i.e., a hardness of about 40 or less on the Shore D hardness scale as described and measured by the American Society for Testing and Materials (ASTM), headquartered in Philadelphia, Pa., at reduced polishing pressures, such as about 2 psi or less. An example of a suitable buffing process and composition is disclosed in U.S. Pat. No. 6,858,540, issued on Dec. 8, 2002, and incorporated herein by reference to the extent not inconsistent with the invention.

Optionally, a cleaning solution may be applied to the substrate after each of the polishing process to remove particulate matter and spent reagents from the polishing process as well as help minimize metal residue deposition on the polishing articles and defects formed on a substrate surface. An example of a suitable cleaning solution is ELECTRACLEAN™ commercially available from Applied Materials, Inc., of Santa Clara, Calif.

Finally, the substrate may be exposed to a post polishing cleaning process to reduce defects formed during polishing or substrate handling. Such processes can minimize undesired oxidation or other defects in copper features formed on a substrate surface. An example of such a post polishing cleaning is the application of ELECTRACLEAN™, commercially available from Applied Materials, Inc., of Santa Clara, Calif.

It has been observed that substrate planarized by the processes described herein have exhibited reduced topographical defects, such as dishing, reduced residues, improved planarity, and improved substrate finish. The processes described herein may be further disclosed by the examples as follows.

### EXAMPLE #1

A copper plated substrate was polished and planarized using the following power application process within a modified cell on a Reflexion Lk Ecmp™ processing system, available from Applied Materials, Inc., of Santa Clara, Calif. A Sematech 754 wafer having a copper layer of about 7,500 Å thick on a barrier layer was placed onto a carrier head in an apparatus having a first Ecmp platen with a conductive polishing article disposed thereon. The copper material was removed by a two step process with a first step of a DC bias applied at 2.5 volts until about 2,000 Å of material was remaining. The second step to remove the remaining 2,000 Å of residual material included applying a DC voltage for approximately 40 seconds and then applying a pulse voltage having a repeating cycle of 2.5 volts for 2 seconds and 1 volt for 1 second over 40 seconds. The remaining copper material on the field of the substrate was observed to have been completely removed.

### EXAMPLE #2

A copper plated substrate was polished and planarized using the following power application process within a modified cell on a Reflexion Lk Ecmp™ processing system, available from Applied Materials, Inc., of Santa Clara, Calif. A Sematech 754 wafer having a copper layer of about 7,500 Å thick on a barrier layer was placed onto a carrier head in an apparatus having a first Ecmp platen with a conductive polishing article disposed thereon. The copper material was removed by a two step process with a first step of a DC bias applied at 2.5 volts for 70 seconds with a soft landing of about 2.2 volts of about 40 seconds removing the copper material to the barrier layer. Any residual material was removed in a second step by applying a pulse voltage having a repeating cycle of 2.5 volts for 2 seconds and 1 volt for 1 second over 40 seconds. The remaining copper material on the field of the substrate was observed to have been completely removed.

While the foregoing is directed to embodiments of the present invention, other and further embodiments of the invention may be devised without departing from the basic scope thereof, and the scope thereof is determined by the claims that follow.

What is claimed is:

1. A method for processing a substrate comprising:
providing the substrate comprising dielectric feature definitions formed between substrate field regions, a barrier material disposed in the feature definitions and on the substrate field regions, and a conductive material disposed on the barrier material;
polishing the substrate to substantially remove a first portion of the conductive material with a direct current bias; and
polishing the substrate to remove a second portion of the conductive material with a pulse bias.

2. The method of claim 1, wherein applying the direct current bias comprises a step process of a first voltage for a first period of time and a second voltage less than the first voltage for a second period of time.

3. The method of claim 1, wherein applying the direct current bias comprises a step process of a first voltage for a first period of time and a second voltage greater than the first voltage for a second period of time.

4. The method of claim 1, wherein applying the direct current bias comprises a step process of a first voltage for a first period of time and a second voltage greater than the first voltage for a second period of time, and a third voltage less than the second voltage for a third period of time.

5. The method of claim 1, wherein applying a pulse bias comprises alternatively applying a first voltage for a first period of time and a second voltage different that the first voltage for a second period of time for a plurality of cycles.

6. The method of claim 5, wherein the first voltage is between about 0 volts and about 3 volts, the second voltage is between about 0 volts and about 3 volts and at least one of the first voltage and second voltage is greater than 0 volts.

7. The method of claim 5, wherein the first period of time is between about 0.01 second and about 20 seconds and the second period of time is between about 0.01 second and about 20 seconds.

8. The method of claim 7, wherein the first period of time and the second period of time are the same period of time.

9. A method for processing a substrate comprising:
providing the substrate comprising dielectric feature definitions formed between substrate field regions, a barrier material disposed in the feature definitions and on the substrate field regions, and a conductive material disposed on the barrier material;
polishing the substrate to substantially remove a first portion of the conductive material;
polishing the substrate to remove a second portion of the conductive material, comprising:
applying a first direct current bias to the substrate;
applying a pulse bias to the substrate; and then
applying a second direct current bias to the substrate.

10. The method of claim 9, wherein applying the pulse bias comprises passivating the exposed conductive material.

11. The method of claim 9, wherein the removing the residual portion of the conductive material comprises:
applying a first direct current bias to the substrate;
removing the a first portion of the residual conductive material to expose the barrier material;
applying a pulse bias to the substrate;
passivating the expose residual conductive material;
applying a second direct current bias to the substrate; and
removing the a second portion of the residual conductive material.

12. The method of claim 11, wherein the removing the first portion of the residual conductive material comprises removing the conductive material in the feature definitions to below the barrier material on the substrate field.

13. The method of claim 9, wherein applying the pulse bias comprises alternatively applying a first voltage for a first period of time and a second voltage different that the first voltage for a second period of time for a plurality of cycles.

14. The method of claim 13, wherein the wherein the second voltage is greater than the first voltage.

15. The method of claim 13, wherein the second voltage is less than the first voltage.

16. The method of claim 13, wherein the first voltage and the second voltage have a positive polarity.

17. The method of claim 13, wherein the first voltage corresponds to an active corrosion state and the second voltage corresponds to a passive corrosion state.

18. The method of claim 13, wherein the first voltage is a pulsed waveform and the second voltage is a pulsed waveform.

19. The method of claim 9, wherein applying the pulse bias comprises applying the pulse bias for a period of time between about 0.1 second and about 10 seconds.

20. The method of claim 9, wherein the polishing the substrate to substantially remove the first portion of the conductive material and the polishing the substrate to remove the second portion of the conductive material is performed on the same platen.
